(19) United States
(12) Patent Application Publication
(10) Pub. No.: US 2012/0100340 A1
(43) Pub. Date: Apr. 26, 2012

(54) FLAT SUBSTRATE WITH ORGANIC BASIS, USE OF SUCH A SUBSTRATE, AND METHOD

(76) Inventors: Natacha Valera, Cham (CH); Edgar Habich, Merenschwand (CH)

(21) Appl. No.: 13/263,782

(22) PCT Filed: Apr. 3, 2010
(86) PCT No.: PCT/EP10/02136

§ 371 Date: Dec. 7, 2011

(30) Foreign Application Priority Data
Apr. 9, 2009 (EP) 09005208.5

(51) Int. Cl. B32B 3/00; B05D 3/12; B05D 1/30; B05D 5/12

(52) U.S. Cl. 428/141; 427/58

(57) ABSTRACT

The invention relates to an organically based flat substrate, wherein the substrate is coated on at least one side and the surface of the coated side has a surface roughness<100 nm. The substrate is used in particular for producing electronic components and/or integrated circuits. According to the method of the invention for producing an organically based substrate, which has at least one electronic component and/or at least one integrated circuit and which is coated on at least one side, the following is provisioned: producing the substrate, having a surface roughness of the coated side of <100 nm, and applying the electronic component and/or integrated circuit to the coated surface of the substrate by printing.

### BACKGROUND

A substrate with an organic basis is known from DE 196 01 358 C2. This substrate is a paper. An integrated circuit that contains prespecified data is embedded in this paper. The integrated circuit is thin compared to the thickness of the paper. The integrated circuit is embedded in the paper mass such that the paper can be printed with a passivation layer that at least partially encloses the integrated circuit.

A flat substrate with an organic basis is also known from EP 1 073 993 B1. This substrate is also a paper that is provided with an integrated circuit. This design is used especially for security documents and banknotes to protect against counterfeiting and falsification. The integrated circuit includes a semi-conducting organic polymer. Polymer chips are flexible and are therefore particularly suitable for use in security documents like banknotes that may be folded. Sharp folds in a chip made of a semi-conducting organic polymer do not affect how the chip functions. In banknote paper, the paper substrate is generally in the range of up to 100 μm (100 micrometers) thick.

Prior art surface roughnesses of flat substrates in the paper industry are greater than 1 μm. These surface roughnesses are attained using finishing processes such as e.g. coating, calendering, or a combination of these methods.

### SUMMARY

Described are embodiments having a flat substrate that makes it possible to print one or a plurality of electronic components, such as e.g. transistors, chips, and/or one or a plurality of integrated circuits, onto the substrate. In the past this printing has only been possible with films that have an inorganic basis. The substrate can be biodegradable. Films with an inorganic basis are not biodegradable. The substrate should be quite strong.

### DETAILED DESCRIPTION OF THE EMBODIMENTS

Certain embodiments have a flat substrate with an organic basis in which the substrate is coated on at least one side. The surface of the coated side can have a surface roughness of less than 100 nm (<100 nanometers).

The substrate is quite strong because it is coated on at least one side. The very low surface roughness of the surface of the coated side of the substrate and the therefore homogeneous structure of this surface make it possible to apply small structures of organic electronics using printing methods.

A coating can comprise pigments, binders, co-binders, and additives that are known in the paper industry. Additives in this context are in particular inter alfa viscosity control agents, wet-strengthening agents, pH regulators, dyes and toning dyes, brighteners, antifoaming agents, slip agents, and cross-linking agents.

A pigment can be selected from the group of clay, kaolin, talcum, calcium carbonate, gloss white, titanium dioxide, synthetic polymer pigments, aluminum silica, zinc oxide, barium sulfate, gypsum, silica, aluminum trihydrate, aluminum oxide, micaceous pigments, diatomaceous earth, silicic acid, boehmite (aluminum hydroxide), or conductive pigments.

A binding agent can be selected from the group of styrene butadiene latex binders, styrene acrylate latex binders, styrene butadiene acrylonitrile latex binders, styrene maleic acid anhydride binders, styrene acrylate maleic acid anhydride binders, polysaccharides, proteins, polyvinylpyrrolidones, polyviny alcohol, polyvinyl acetates, cellulose and cellulose derivatives, polyurethanes, polyesters, acrylic acid, polymers based on ethylene acrylic acid wax, or polyethylene.

A cross-linking agent can be selected from the group of glyoxal resin, epoxide resin, ammonium or potassium zirconium carbonate, formaldehyde donors like melamine formaldehyde, urea-melamine formaldehyde, and partly or fully methylated derivatives, isocyanates.

The substrate produced in accordance with this formula is resistant to the following chemicals and related substances: water, developers with an amine basis, acid, isolators in organic solvents, acetone, iodine as a caustic agent, semiconductors in organic solvent, photo-resist. No change in the surface structure of the substrate can be detected after it has come into contact with the aforesaid chemicals; the surface coating is not affected. This is especially positive with respect to the production and functionality of electronic components, such as integrated circuits, produced with inorganic and organic electrically conductive substances (lacquers and inks using printing methods, including etching methods). The qualitative and quantitative assessment of the final product (thus the yield, reading rate of the printed electrical components and circuits) thus is no different from those with an inorganic basis.

It is furthermore advantageous that the described substrate has material strengths, especially strain behavior, that permit it to place multilayer structured layers over one another in register in a continuous printing process.

The substrate can have a surface roughness of less than 100 nm on each side. For example, the surface roughness can be less than 50 nm on at least one side of the substrate, such as 10 to 40 nm.

The substrate can be a paper or biopolymer or a paper with a layer on the back and/or front that is made of biopolymer or a biopolymer that is finished with a paper coating on the back and/or front.

The substrate especially has the following layer structure:

a. Paper coating-paper, or

b. Paper coating-paper-paper coating, or

c. Paper coating-biopolymer, or

d. Paper coating-biopolymer-paper coating, or

e. Biopolymer-paper, or

f. Biopolymer-paper-biopolymer, or

g. Paper coating-biopolymer-paper, or

h. Paper coating-biopolymer-paper-biopolymer-paper coating.

The substrate, which is especially paper, is coated on at least one side. Furthermore, the substrate that is coated on at least one side is then calendered. A blade coating can be applied to the substrate as a base coat and then a top coat is applied by means of curtain coating. An intermediate coating may be applied between the base coat and top coat.

A substrate with low surface roughness, is attained by coordinating substrate and coating formulas and by coordinating coating methods and smoothing methods with one another. These methods may be performed in both inline and offline processes.

Thus the temi substrate is understood to include the flat starting element with the organic basis (paper or biopolymer) that is coated once or multiple times on at least one side in order to attain the desired low surface roughness of less than 100 nm.

The surface of the substrate can have very low surface roughness: less than 100 nm. The surface roughness is determined by measuring the surface profile of the substrate using a 12 μm needle head at 3 mg pressure. The angle of inclination of the surface profile of the substrate is especially less than 10° at 5 μm, especially when the surface roughness is 10 to 40 nm.

This very smooth surface of the substrate has a homogeneous structure that makes it possible to produce small structures of organic electronics that are less than 50 nm thick, especially that are less than 20 nm thick, using printing methods. The substrate surface is especially suitable for producing organic polymer electronics since the technical functionality of printing components is assured by the lack of the major surface differences (peaks) typical for paper.

The substrate can be a coated substrate, especially a coated paper. The substrate is coated on at least one side. At least one coating can be provided to each side of the substrate. In particular two or three coatings are applied to each side. Then calendering is performed on at least one side.

In general all coating methods may be used. These include a size press, a spraying method, doctor blade coating, blade coating, bar coating, reverse roll type coating, air knife coating, curtain coating, or combinations of these methods.

The substrate is especially printed using rotogravure, flexographic, offset, screen, or inkjet printing. Production methods that are combined with one another in these methods are especially suitable. Both continuous and non-continuous printing processes are suitable.

The substrate can be used for producing electronic components (e.g., integrated circuits), such as those that are produced by printing.

A method is provided for producing a substrate with an organic basis that is provided with at least one electronic component (e.g., at least one integrated circuit) and that is coated on at least one side. The substrate is first produced with a surface roughness of less than 100 nm on the coated side. Then the electronic component (e.g., integrated circuit) is applied to the coated surface of the substrate by means of printing.

The process described herein makes it possible to satisfy the requirements of the described printing process with a flat substrate that has an organic basis. In the past these requirements were only attained using plastic films (e.g., PET). The described substrates can achieve enhanced biodegradability compared to films with an inorganic basis.

The substrate is suitable for printing with inorganic and organic electrically conductive printing inks, lacquers, and inks for producing electronic components (e.g., integrated circuits). This is due to the surface roughness (Rz<100 nm) being reduced by coordinating substrate and coating formulas, coating methods, and

smoothing methods with one another. The latter may be performed both in inline and offline processes. In addition, the suitability of the substrate can be attained while avoiding use of chemicals that come into contact with the substrate as described in the production process. The qualitative and quantitative evaluation of the final product thus is no different from those for the final products that have an inorganic basis.

The following specifies the production of one exemplary embodiment of the flat substrate with an organic basis:
starting from a sized raw paper,
three coatings are applied to the raw paper, specifically:

1. Base coat: pigmented coating—applied using blade method;

2. Intermediate coat: pigmented coating, applied using curtain coating method;

3. Top coat: polymer coating, applied using rolling doctor or curtain coating method.

After it has been coated, the paper is calendered.

What is claimed is:

1-17. (canceled)

18. A substrate having opposite sides, comprising:
an organic base layer having opposite sides, and a coating layer on at least one side of the organic base layer, wherein at least one side of the substrate has a surface roughness suitable for receiving a printed electronic component.

19. A substrate in accordance with claim 18, in which the organic base layer is a paper.

20. A substrate in accordance with claim 18, in which the organic base layer is a biopolymer layer.

21. A substrate in accordance with claim 19, in which the coating layer comprises a biopolymer.

22. A substrate in accordance with claim 18, in which the coating layer is a paper coating.

23. A substrate in accordance with claim 21, further comprising a paper coating layer on at least one biopolymer coating layer.

24. A substrate in accordance with claim 18, wherein at least one side of the substrate has a surface roughness less than 100 nm.

25. A substrate in accordance with claim 24, wherein at least one side of the substrate has a surface roughness less than 50 nm.

26. A substrate in accordance with claims 24, wherein at least one side of the substrate has a surface roughness from about 10 nm to about 40 nm.

27. A substrate in accordance with claim 1, further comprising at least one electronic component coated on at least one side of the substrate.

28. A substrate in accordance with claim 24, ingredients of the coating formula being pigments, binders, co-binders, and additives.

29. A substrate in accordance with claim 24, additives being viscosity control agents, wet-strengthening agents, pH regulators, dyes and toning dyes, brighteners, antifoaming agents, slip agents, and cross-linking agents.

30. A substrate in accordance with claim 24,
the pigment being selected from the group of clay, kaolin, talcum, calcium carbonate, gloss white, titanium dioxide, synthetic polymer pigments, aluminum silica, zinc oxide, barium sulfate, gypsum, silica, aluminum trihydrate, aluminum oxide, micaceous pigments, diatomaceous earth, silicic acid, boehmite (aluminum hydroxide), or conductive pigments, and/or
the binding agent being selected from the group of styrene butadiene latex binders, styrene acrylate latex binders, styrene butadiene acrylonitrile latex binders, styrene maleic acid anhydride binders, styrene acrylate maleic acid anhydride binders, polysaccharides, proteins, polyvinylpyrrolidones, polyviny alcohol, polyvinyl acetates, cellulose and cellulose derivatives, polyurethanes, polyesters, acrylic acid, polymers based on ethylene acrylic acid wax, or polyethylene, and/or
the cross-linking agent being selected especially from the group of glyoxal resin, epoxide resin, ammonium or potassium zirconium carbonate, formaldehyde donors like melamine formaldehyde, urea-melamine formaldehyde, and partly or fully methylated derivatives, isocyanates.

31. A substrate in accordance with claim 24, the substrate having the following layer structure:
a. Paper coating-paper, or
b. Paper coating-paper-paper coating, or
c. Biopolymer-paper, or
d. Biopolymer-paper-biopolymer, or
e. Paper coating-biopolymer-paper, or
f. Paper coating-biopolymer-paper-biopolymer-paper coating.

32. A substrate in accordance with claim 24, the substrate having a surface roughness of less than 100 nm on each side.

33. A substrate in accordance with claim 24, the surface roughness on at least one side of the substrate being less than 50 nm.

34. A substrate in accordance with claim 24, the angle of inclination of a surface profile of at least one side of the substrate being less than 10° at 5 μm.

35. A substrate in accordance with claim 24, the paper being coated on both sides.

36. A substrate of claim 27, which is a security document.

37. A method for producing a substrate having an organic base layer, and supporting at least one electronic component, comprising:
producing a substrate comprising an organic base layer having opposite sides, and a coating layer on at least one side of the organic base layer, wherein the coated side has a surface roughness less than 100 nm; and
applying at least one electronic component to the coated surface of the substrate by means of printing.

38. A method in accordance with claim 37, which the substrate is produced using coating and smoothing occurring in an inline or offline process.

39. A method in accordance with claim 37, the electronic component being produced by means of inorganic or organic electrically conductive substances, lacquers, or inks.

40. A method in accordance with claim 37, in which the substrate is calendered before applying the electronic component.

41. A method in accordance with claim 37, in which the substrate is produced using a blade coating applied to the base layer as a first coat and a top coat applied by curtain coating.

42. A method in accordance with claim 37, the substrate being printed with rotogravure, flexographic, offset, screen, or inkjet printing.

43. A method in accordance with claim 37, the substrate being printed continuously or discontinuously.

44. A method in accordance with claim 37, further comprising printing indicia on the substrate to produce a security document.

45. A method in accordance with claim 37, further comprising printing indicia on the substrate to produce a banknote.
